(19) United States
(12) Patent Application Publication
(10) Pub. No.: US 2004/0062967 A1
(43) Pub. Date: Apr. 1, 2004

(54) Fuel cell equipped with identical polar plates and with internal fuel and coolant circulation

(76) Inventor: Jean-Edmond Chaix, Plerrevert (FR)

Correspondence Address: Pearne Gordon, McCoy & Granger, Suite 1200, 526 Superior Avenue East, Cleveland, OH, 44114-1484, US

(21) Appl. No.: 10/466,010

(22) PCT Filed: Jan. 9, 2002
(86) PCT No.: PCT/FR02/00065

(30) Foreign Application Priority Data
Jan. 10, 2001 (FR) 01/00254

(51) Int. Cl. H01M 8/10; H01M 8/18; H01M 2/00; H01M 2/02; H01M 2/08; H01M 2/14

(52) U.S. Cl. 429/32; 429/19; 429/34; 429/35; 429/38; 429/39

(57) ABSTRACT

The fuel cell comprises a single type of polar plates, these polar plates being adjacent to each other with the top of each basic element being placed next to the bottom, from the adjacent basic element, and is globally leak tight.

The relief on the outer face of each polar plate (10) is made of bushings (17, 25, 26) that are nested in the empty spaces of the relief of the immediately adjacent polar plate. The cell cooling fluid circulates in the empty space formed between two polar plates. Holes (12A, 12B, 12C) enable the passage of attachment tie rods and the circulation of fuel and oxidant distributed through circulation ducts (11) in the form of a double nested spiral, and cooling fluid.

Applications in electricity generation to supply energy to traction motors for public transport vehicles and stationary electricity generating systems.

### FIELD OF THE INVENTION

The invention relates to the field of fuel cells consisting of a stack of a large number of basic elements each comprising two polar plates through which the oxidant and the fuel are transferred to a separating membrane between the two polar plates.

Some fuel cells, for example of the solid polymer electrolyte type, are used for applications particularly in electrical vehicles for which many development studies are now being carried out in order to provide solutions to the pollution caused by the use of vehicles with a thermal combustion engine. This is the case for surface public transport vehicles such as buses, tramways and other trolley buses.

There are many other possible applications, particularly on fixed installations such as stationary electricity generating systems, like those used in hospitals or other service buildings in which it must be guaranteed that the electricity power supply cannot be interrupted.

### PRIOR ART AND PROBLEM THAT ARISES

Many fuel cells are composed of a sequence of basic elements that themselves comprise two electrodes, including one anode and one cathode to which an oxidant and a fuel are continuously supplied, and that remain separated by an ion exchanging membrane acting as an electrolyte. The ion exchanging membrane may be formed from a solid polymer electrolyte and it separates the anode compartment in which the fuel (for example hydrogen) is oxidised, from the cathode compartment in which the oxidant (such as oxygen in the air) is reduced. Therefore two simultaneous reactions take place at this level, oxidation of the fuel at the anode and reduction of the oxidant at the cathode. These two reactions are accompanied by a potential difference being set up between the two electrodes.

When oxygen is used as the oxidant, for example in the form of air, and the fuel used is pure gaseous hydrogen, the H⁺ and O⁻ ions combine and generate electricity in the form of this potential difference. The reaction at the anode may be defined as follows:

2H₂+4OH⁻→4H₂O+4e⁻

The reaction at the cathode is explained by the following formula:

O₂+2H₂O+4e⁻→4OH⁻

Therefore, each basic element of a stack in a fuel cell is composed of a central assembly comprising the membrane sandwiched between the two electrodes, this assembly itself being placed between two plates called “polar plates”. These plates perform several functions.

The first of these functions is to create contact between the assembly combining the membrane and the electrodes, and firstly the fuel (for example hydrogen), and secondly the oxidant (for example air containing oxygen). This is done by providing a channel over the entire face of the polar plates in contact with the membrane. Each channel is provided with an inlet into which the oxidant or the fuel enter, for example in wet or dry gaseous form, and an outlet from which neutral gases are evacuated, the water generated by the oxidation—reduction reaction on the air side and the residual humidity of hydrogen on the hydrogen side. Obviously, the two circuits must be perfectly sealed with respect to each other and each must be sealed from the outside.

The second function of the polar plates is to collect electrons produced by the oxidation—reduction reaction.

The third function of these polar plates is to evacuate heat produced jointly with the electrons during this hydroreduction reaction.

Consequently, these polar plates are necessarily firstly capable of conducting electricity, and secondly they are resistant to corrosion caused by the oxidant or the fuel, in other words oxygen in the air and hydrogen. Therefore, they may be made of carbon, or a plastic with a filler, or a non-oxidising alloy such as stainless steel, austeno-ferritic steel, austenitic steel, chromium-nickel alloy, chromium plated aluminium, etc.

Furthermore, within the framework of fuel cells composed of a stack of basic elements, the polar plates also perform a collective function for the entire stack, such as the creation of supply manifolds and fuel and oxidant evacuation manifolds and the heat exchange function, for cooling of the cell formed by the stack. Therefore, the shape of the polar plates is complex and there are frequently two different types, one for each side of the basic element. Furthermore, the manifolds are designed to pass through the membrane at each stage, which causes leak tightness problems since the gaskets of the manifolds apply pressure on the membranes. The gasket which creates a leak tight joint between a two-pole plate and the membrane/electrode assembly and the other two-pole plate then has to have a fairly complicated shape, something like the shape of the cylinder head gasket in an automobile vehicle. Consequently, a single pressure force is applied to the gasket, which is the same as that applied to all elements in the stage. This force is such that it can cause damage to the membrane, which would deteriorate them so that the contact is no longer perfectly leak tight.

For the construction of fuel cells, there is a need to limit polar plate fabrication steps, and particularly long and expensive machining operations, and especially to solve these leak tightness problems, in order to reduce the production cost.

The purpose of the invention is to propose a design for a stack of fuel cells in order to simplify the fabrication of the different parts, and particularly machining of polar plates and electrodes, without reducing the efficiency and leak tightness of the fuel cell assembly.

### SUMMARY OF THE INVENTION

Consequently, the main purpose of the invention is a fuel cell composed of several basic elements placed in a stack and each comprising:

a membrane/electrode assembly;

two polar plates placed on each side of the membrane/electrode assembly, one to bring in the oxidant and evacuate products derived from the oxidation—reduction, and the other to bring in the fuel and evacuate products derived from this oxidation—reduction, all the polar plates defining lateral supply and evacuation manifolds as a result of the way in which they are stacked, and each being provided with:

an inner face placed in contact with the membrane/electrode assembly and defining the fuel and oxidant circulation channel, and

an outer face placed in contact with the outer face of the adjacent basic element, the external surfaces of the polar plates all have the same relief compatible with mutual nesting between them when they are placed top to bottom, in other words one facing the other in the opposite directions.

According to the invention, each polar plate has at least three pairs of holes around its periphery to form four vertical manifolds to supply fuel and oxidant and to evacuate oxidation—reduction products, and at least two manifolds for the supply and the evacuation of a cooling liquid, and for each basic element there is an O-ring at the outside of the membrane around the holes forming horizontal passages and placed between each polar plate of a particular element. This is a mean of only fabricating a single type of polar plates for a compact fuel cell, reducing the thickness of the stack and not damaging the membranes by the gaskets.

In making water cooled fuel cells, the volume defined by the two outer faces of the two adjacent polar plates nested in each other comprises empty spaces to enable the passage of cooling fluid.

In order to supply fuel and oxidant, it is advantageous if the polar plate has horizontal passages and a junction cavity connecting the vertical manifolds to the fuel and oxidant circulation channels.

In this case, it is advantageous to use an O-ring placed on the inner face around the circulation channel and the basic element.

In the embodiment of the fuel cell with a round section, the circulation channel of the inner face of each polar plate may be in the form of a double nested spiral joining together at the center.

The stack of several basic elements thus forming the fuel cell is kept tight, preferably, by tie-rods passing through each polar plate.

The relief on the outer face of each polar plate may have a thrust pad and bushings around the manifold holes and a few tie-rod holes, in order to mechanically reinforce each basic element.

In this case, it is advantageous to use bushing O-rings, to form a leak tight joint of the manifolds inside the bushings.

These O-rings can be eliminated if the bushings in each polar plate are brazed on the outer face of the adjacent polar plate.

If the basic elements are round, the fuel and oxidant circulation channels are in the form of a nested double zigzag on each inner face of each polar plate, beginning and ending at one side and meeting at the other side.

If these basic elements are round, the circulation channel for each inner face of each polar plate may also have a zigzag shape going from one side of the plate to the other.

In order to make the cell globally leak tight, a global peripheral seal is provided between the polar plates in two adjacent basic elements.

### LIST OF FIGURES

The invention and its various technical characteristics and advantages will be better understood after reading the following description accompanied by a few figures, that show:

FIG. 1, a first exploded sectional view of a basic element, and an installed basic element of the fuel cell according to the invention, along line 1-1 in FIG. 3;

FIG. 2, a second sectional view of an installed basic element of the fuel cell according to the invention, along line 2-2 in FIG. 3;

FIG. 3, an exposed top view showing a basic element of the fuel cell according to the invention;

FIGS. 4A, 4B, 4C showing possible embodiments of circulation channels in basic elements of the fuel cell according to the invention;

FIG. 5, showing an exploded view of a fuel cell according to the invention with only a small number of basic elements in the stack;

FIG. 6, showing an exploded view of the detail of the inside of a connection socket and the attachment system for a tie-rod of the fuel cell according to the invention; and

FIG. 7, a sectional view of a fuel cell according to the invention, along the line 1-1 in FIG. 3.

### DETAILED DESCRIPTION OF AN EMBODIMENT OF THE INVENTION

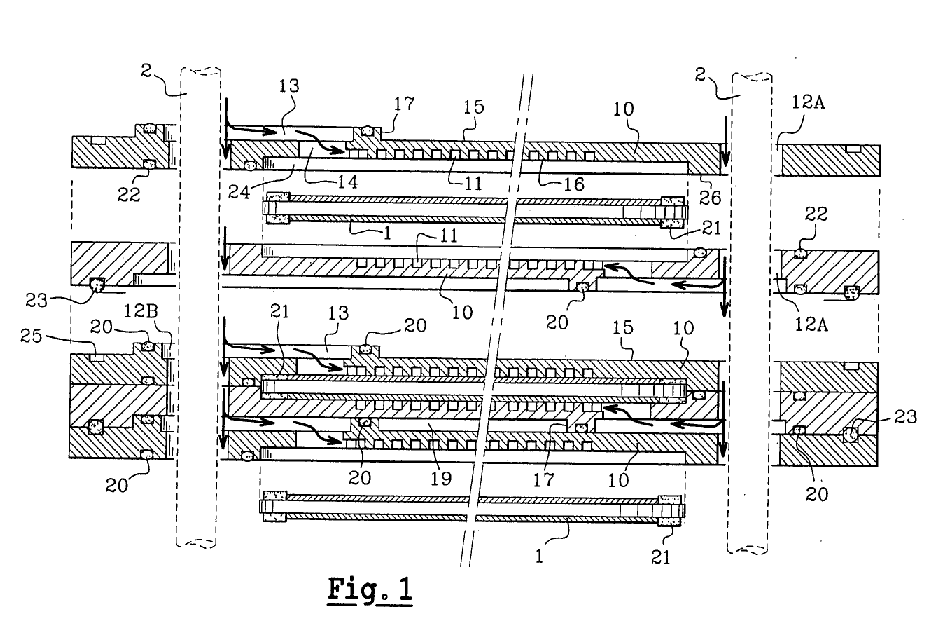

The top part of FIG. 1 shows an exploded view of a basic element, in other words a view in which the main parts are separated from each other. The most important main parts are a membrane/electrode assembly 1 and two polar plates 10, inside which the membrane/electrode assembly 1 is trapped. The same basic element is shown assembled in the lower part of FIG. 1, adjacent to a polar plate of a lower adjacent element.

The membrane/electrode assembly 1 is actually composed of an ion exchanger type membrane, for example formed from a solid polymer electrolyte and is used to separate the anode compartment from the cathode compartment. The thickness of this membrane is of the order of a few tens to a few hundreds of micrometers and therefore it is a compromise between the mechanical strength and the pure resistance drop. The two electrodes that are in contact with the membrane comprise an active zone, for example composed of porous graphite covered by grains of noble metal, and a diffusion zone, for example composed of a hydrophobic porous material.

Note that in the main embodiment of the fuel cell design according to the invention, the shape of the fuel cell should be round, in other words the polar plates 10 and the membrane/electrode assembly 1 are also round.

Each polar plate 10 has two faces. On the first face, called the outer face 15, two circular bushings 17 are cut and are each tangent to the periphery of the polar plate 10, and each surrounds a hole 12A or 12B formed close to the periphery of the polar plate 10. Each of these holes 12A or 12B, combined with corresponding holes 12A or 12B in the other polar plates 10, forms a vertical fuel and oxidant supply manifold or a vertical manifold for evacuation of products derived from oxidation—reduction. Each bushing 17 bears on the outer face 15 of the adjacent basic element. As can be seen on the lower part of the Figure, there is then a cavity 19 between two adjacent polar plates 10, between the bushing 17 and around them. In other words, there is a passage between each basic element passing through the fuel cell. This passage is used for circulation of water to cool the basic elements of the fuel cell. A horizontal passage 13 is formed inside each bushing 17, on the outer face 15, and thus connects a hole 12A or 12B with the end of a circulation channel 11, through a junction cavity 14. A bushing O-ring 20 completes the bushing 17 to make the vertical manifolds formed by the holes 12A and 12B leak tight. It is of overriding importance to make sure that each O-ring 20 that surrounds a hole 12A or 12B does not apply any pressure onto part of or the end of the membrane of the membrane/electrodes element 1, and that this pressure is only applied to the inner face 16 of the adjacent polar plate. This prevents damage to the membrane and homogenizes or uniformly distributes the clamping pressure over the entire gasket.

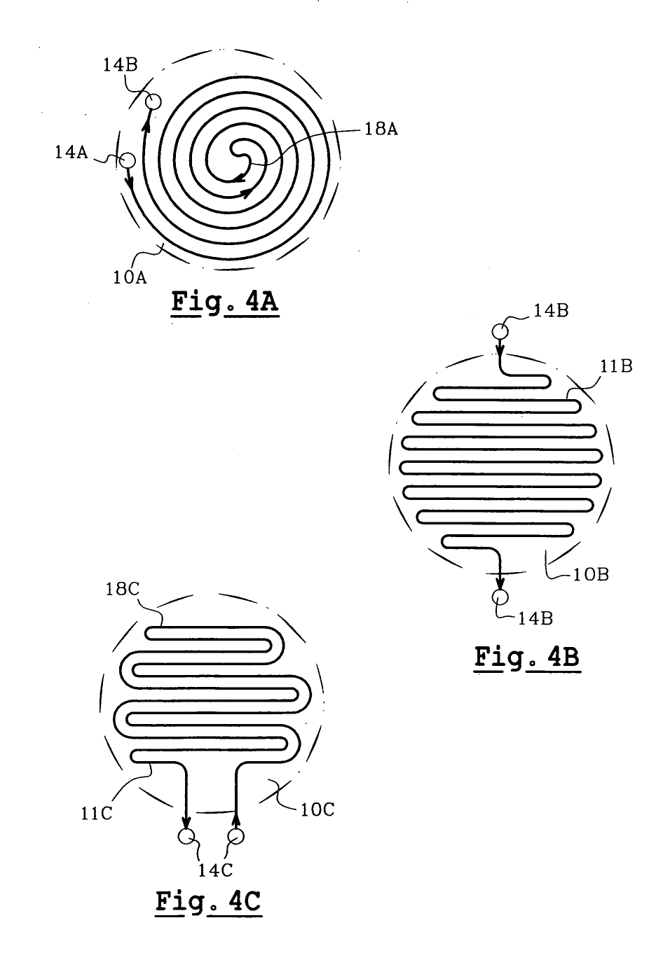

There is a circulation channel 11 on the inner face 16 of each polar plate 10, which is used either by the fuel or the oxidant, each of them coming into contact with a surface of the membrane/electrode element 1, in other words with an electrode. The line of these circulation channels 11 must be as long as possible to achieve a maximum contact surface between the electrodes and the oxidant or the fuel. FIGS. 4A, 4B and 4C show possible geometries of these channels in detail.

Each inner face 16 has a small cavity, like countersinking 24, the depth of which is slightly less than half the thickness of the membrane/electrode assembly 1, so that the membrane/electrode assembly can be trapped in the space formed by two cavities 24 in two polar plates 10 placed facing each other. There is then a small clearance between these plates, used to make the circulation channels 11 leak tight, using two large circular gaskets 21 placed around the two electrodes, on each side of the membrane, around its periphery. This thus makes the vertical manifolds leak tight by means of large manifold O-rings 22 surrounding each hole 12A on one of the two polar plates, and which are thicker than the large circular gaskets 21.

Thus, it can be understood that in starting from a vertical supply manifold, fuel or oxidant can be circulated throughout the circulation channel 11 to exit through a vertical evacuation manifold also formed in a series of holes 12A and 12B;

The arrows shown in FIG. 1 show the two possible circulations of the oxidant and the fuel, each of them circulating one side of the membrane/electrode assembly 1 in the circulation channel of one of the two polar plates 11.

FIG. 1 also shows that the stack of basic elements forming the fuel cell is clamped together by tie rods 2, four of which pass through the holes 12A and 12B. It can be seen that there is a clearance between these tie rods 2 and the inside wall of the holes 12A and 12B so that four of these sequences of holes 12 can form four fuel or oxidant supply or evacuation manifolds.

There is a peripheral global gasket 23 surrounding all the manifold holes 12A and 12B between each polar plate 10 around the periphery of each outer surface 15. Since all plates 10 are of the same type, in other words they are identical, a half-groove 25 is formed in each plate. The following sections describe the purpose of this peripheral global gasket 23.

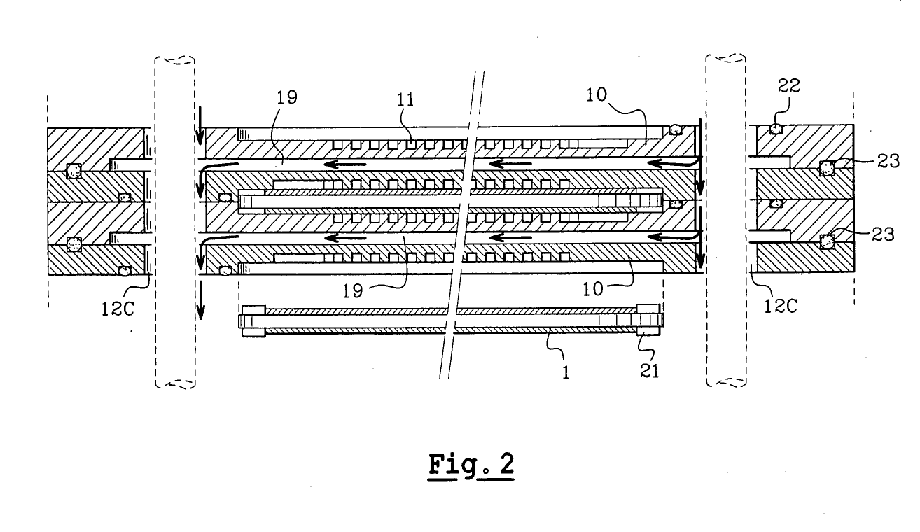

FIG. 2 is a different section showing the elements described above. This figure shows a section taken through the cooling fluid manifolds 12C, rather than the oxidant or fuel manifolds 12A and 12B. In the cooling fluid manifolds, the circulation channels are no longer in communication with these cooling fluid manifolds 12C. However, they are in direct communication with the cavity 19 located between two polar plates of two adjacent basic elements and in which the cooling fluid circulates. The arrows indicate the direction of circulation of the cooling fluid that passes from one manifold to the other passing through all the cavities 19. The result is a need for leak tightness with respect to this cooling fluid. However, the manifold O-rings 22 are still used to form a leak tight joint at the joint plane of cooling fluid manifolds 12C, between the two polar plates 10 of the same basic element.

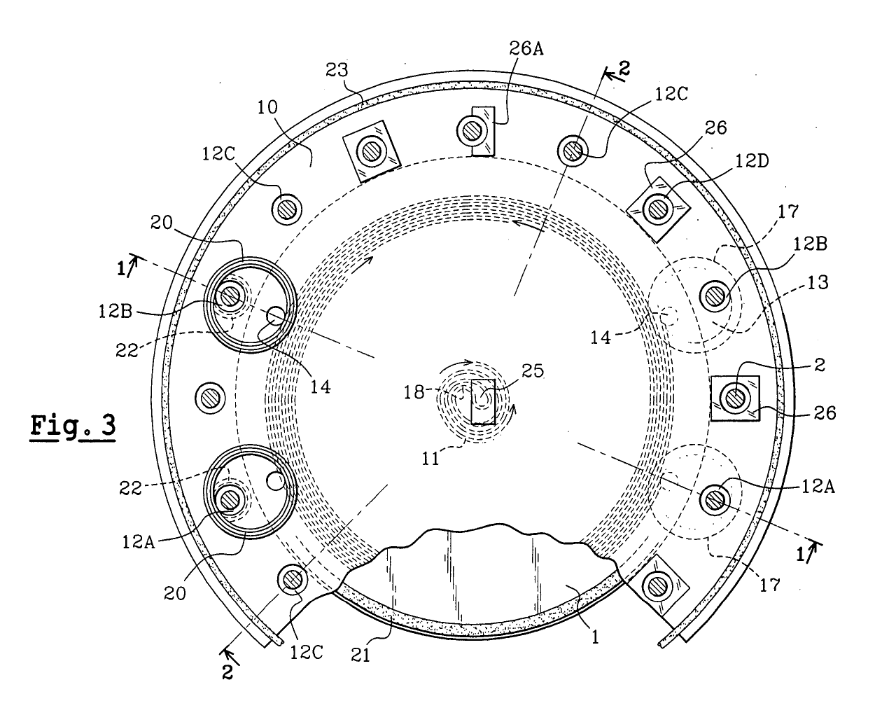

FIG. 3 gives a better understanding about how the tie rods 2 are distributed at the periphery of the polar plates 10. In the embodiment shown here, sixteen tie rods 2 are provided in sixteen vertical channels composed of a sequence of holes 12A, 12B, 12C and 12D. Four of these channels references 12A and 12B are placed inside a bushing 17, each of which forms a part of a fuel or oxidant manifold. Therefore, each of these manifolds thus formed is hydraulically connected with a junction cavity 14 through a horizontal passage 13 that forms the inside of the bushing 17 made leak tight by means of the bushing O-ring 20 that accompanies it. Thus, the oxidant and the fuel supply and evacuation are made through a pair of leak tight vertical manifolds. Twelve other holes 12B are also provided around the periphery of the polar plate 10 to enable the passage of twelve other tie rods 2.

This FIG. 3 shows a nested double spiral shape of a circulation channel 11. Therefore, the circulation channel is very long, since it runs over the entire surface of an inner face of a polar plate 10, except at its periphery. At the center, the two strands of the spiral channel 11 are joined together at a central junction 18. This shape may be machined on a high speed lathe. The end of each circulation channel 11 communicates directly with the junction cavity 14.

The global peripheral gasket 23 can also be seen around the periphery of this polar plate 10, which makes the entire inside surface of this polar plate 10 leak tight by surrounding all holes 12A and 12B and also holes 12C that will be used for the cooling fluid. The cooling fluid can arrive through one of these holes, circulate around the entire surface of the polar plate 11 and cool it, and then leave through another hole 12C. The peripheral global gasket 23 also surrounds any other holes 12D that only form passages for tie rods, to hold the stack that forms the fuel cell tightly clamped.

Furthermore, two lines 1-1 and 2-2 are marked in FIG. 3 to show the location of the sections corresponding to FIGS. 1 and 2.

With reference to FIGS. 4A, 4B and 4C, a comparison can be made between several types of possible and feasible circulation channels. FIG. 4A shows a round polar plate 10A and uses the same type of circulation channel 11A described above and marked as reference 11 in the previous figures, in the form of a nested round double spiral, with a central junction 18A. The junction cavities 14A can be placed at any position around the periphery of the polar plates 10A, provided that each communicates with a vertical manifold.

FIG. 4B shows another type of circulation channel 11B, once again for a round polar plate 10B. However, the two junction chambers 14B are placed on opposite side. The shape of the circulation channel 11B is a zigzag, gradually passing along the entire diameter of the polar plate 10B.

Finally, FIG. 4C shows a round polar plate 10C. In this case, the circulation channel 11C may have a nested double zigzag shape around the entire round surface and joined together at a central junction 18C. As shown in FIG. 3A, the junction chambers 14C may be placed adjacent to each other, but this is not compulsory.

It would also be possible to envisage non-square shapes for the polar plate, for example rectangular or diamond shaped, or polygonal with more than four sides.

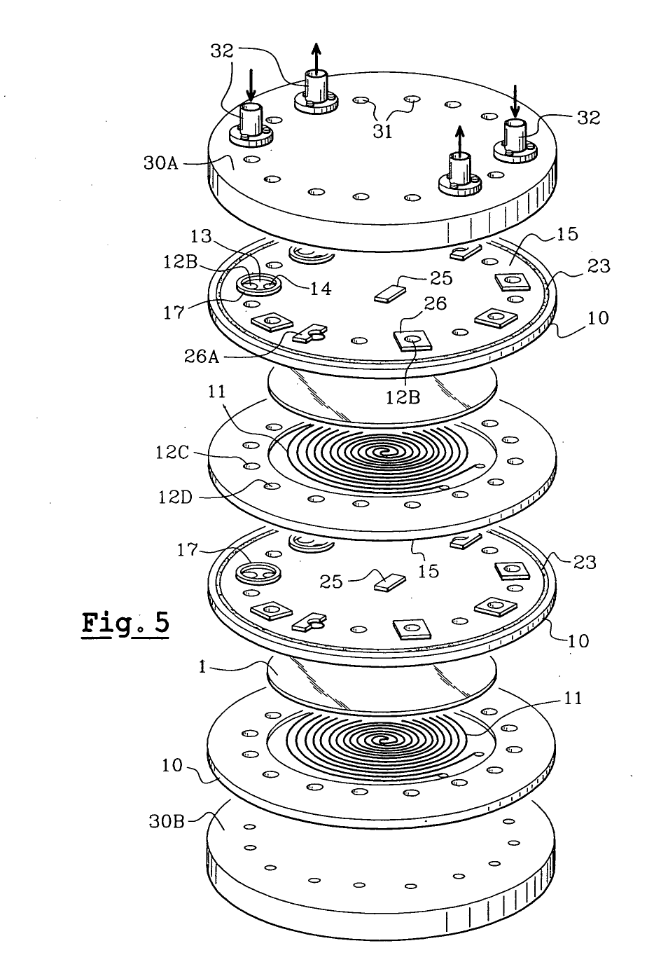

FIG. 5 shows an exploded view of a fuel cell according to the invention with two basic elements each comprising a membrane/electrode assembly 1 each surrounded by two polar plates 10. In particular, this FIG. 5 shows bushings 17 without their O-rings, each surrounding a passage hole 12A or 12B and a junction cavity 14. A distinction is also made on the outer face 15 of the polar plates 10, the bushings 26 and 26A being formed around passage holes 12C and 12D that are not in communication with the junction cavities 14 and which are only used for circulation of coolant and for allowing attachment tie rods to pass. Furthermore, a thrust pad 25 is placed close to the middle of the outer face 15 of each polar plate 10 and completes the thrust surface that forms the upper surfaces of the bushings 17 and 26 with the outer face of the polar plate immediately adjacent to it.

One variant embodiment consists of eliminating the O-rings (mark 20 in FIG. 2) of bushings 17 and 26, and brazing these bushings on the outer face of the polar plate of the adjacent basic element on which they are in contact. Thus, the manifolds are also made leak tight.

This FIG. 5 also shows that once two adjacent polar plates are in contact with each other, there is a free volume between them with several accesses towards the outside of the stack. This enables circulation of a large quantity of cooling water around the cell, through the holes 12C provided for circulation of coolant.

In fact, the relief of all the polar plates 10 is the same. The two polar plates 10 of the two adjacent basic elements are identical, but they can be nested in each other, when they are turned over one facing the other, the outer face of one in contact with the outer face of the other. FIGS. 1, 2 and 3 show that the bushings 17 around the holes 12A and 12B are provided alternately on one and then the other polar plate, so that this nesting is possible. The same is true for bushings 26 around holes 12B. Two bushings are cut into two half bushings 26A each fixed to one or the other polar plate 10. In fact, the axis about which one of the two polar plates 10 is turned to come into contact with the other passes between the half bushings 26A. Similarly, the thrust pads 25 are not in the center of each outer face 15, but are on each side of this axis of rotation; so as to not interfere with each other during assembly.

Two end plates are provided at the ends of this stack, a lower plate 30B and an upper plate 31 provided with holes 31 through which the attachment tie rods can pass. Furthermore, it is equipped with four connection sockets 32 placed facing the holes 31 that form the ends of the oxidant and fuel circulation manifolds.

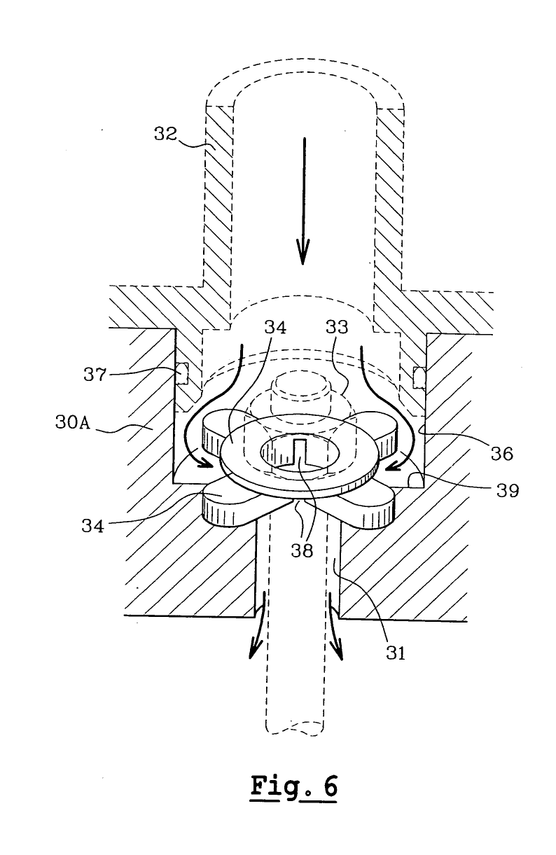

FIG. 6 shows details of the inside of the connection bushings 32, jointly with the tie rod clamping system. Each connection socket 32 penetrates into a hole 36 in the upper end plate 30A to be fixed to it in a leak tight manner through the use of an O-ring 37 placed on the inside wall of the hole 36. The tie-rod 2 is kept clamped against the end plate 30 by means of a tightening nut 33 that bears over its entire surface on a washer 35, itself bearing on a thrust cross member 34 with four branches bearing on the bottom 39 of the hole 36. There is a passage 38 between each branch of the support cross member 34, thus enabling oxidant or fuel to pass inside the connection socket 32 in the passage hole 31 in the top end plate 30A. Thus, the tie rod 2 can pass and fluids can circulate at the same time.

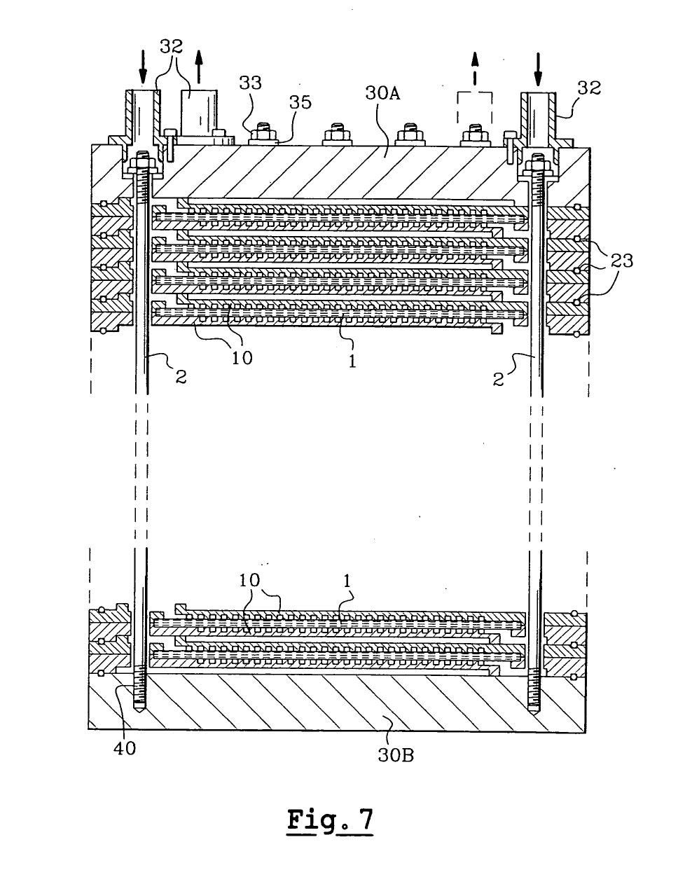

FIG. 7 shows that it is thus possible to make a fuel cell composed of a stack comprising a large number of basic elements stacked on each other and tightened to each other. In particular, this FIG. 7 shows the circulation of oxidant and fuel, in which arrows are used to diagrammatically represent the circulation direction entering or leaving the connection sockets 32. It can also be seen that tie rods that are not located in vertical manifolds are simply tightened by a nut 33 and a washer 35 bearing on the upper surface of the upper attachment plate 30A. In one lower attachment plate 30B, the tie rod 2 is simply screwed into a threaded hole 40.

Fabrication is very much facilitated by the arrangement of the circulation channel 11A in FIGS. 3 and 4A. It can be made on a lathe, in the same way as a thread is made, starting from the middle and working towards the outside of the surface of the polar plate 10. Thus, the two parts of the nested double spiral can be made in two machining operations. The central junction 18A is made by a central countersinking.

Note also that mutual nesting of polar plates is a means of reducing the height of the stack forming the cell.

Obviously, the fact that the all the polar plates are the same considerably reduces the cell manufacturing cost.

Finally, the stack is sufficiently well cooled at all times, through the cavities remaining between the basic elements.

1. Fuel cell comprising a plurality of basic elements placed in a stack and each comprising:
a membrane/electrode assembly (1); and
two polar plates (10, 10A, 10B, 10C) placed on each side of the membrane/electrode assembly (1), one to bring in the oxidant and evacuate products derived from the oxidation—reduction, and the other to bring in the fuel and evacuate products derived from this oxidation—reduction, all the polar plates (10, 10A, 10B, 10C) defining lateral supply and evacuation manifolds as a result of the way in which they are stacked, and each being provided with:
an inner face (16) placed in contact with the membrane/electrode assembly (1) and defining a fuel and oxidant circulation channel (11, 11A, 11B, 11C), and
an outer face (15) placed in contact with the outer face of the adjacent basic element, the outer faces (15) of the polar plates (10, 10A, 10B, 10C) all having the same relief compatible with mutual nesting between them when they are placed top to bottom, in other words one facing the other in the opposite directions,
characterised in that each polar plate (10, 10A, 10B, 10C) has at least three pairs of holes (12A, 12B, 12C) around its periphery to form four vertical manifolds to supply fuel and oxidant and to evacuate oxidation—reduction products, and at least two manifolds for the supply and the evacuation of a cooling fluid, and in that for each basic element, there is an O-ring (22) located at the outside of the membrane around the holes (12A, 12B, 12) themselves forming the vertical manifolds, and between the polar plates (10) of a particular basic element.

2. Fuel cell according to claim 1, characterised in that the volume defined by the two outer faces (15) of the two adjacent polar plates (10) nested in each other comprises empty spaces (19) to enable the passage of the cooling fluid.

3. Fuel cell according to claim 1, characterised in that each polar plate (10) has a horizontal passage (13) on its outer face (15), and a junction cavity (14) connecting the vertical manifolds to the fuel and oxidant circulation channels (11).

4. Fuel cell according to claim 1, characterised in that it comprises an O-ring (21) placed on the inner face (16) of each polar plate (10) around each circulation channel 11, 11A, 11B, 11C and the membrane/electrode assembly (1).

5. Fuel cell according to claim 1, characterised in that it has a round section, and that the circulation channel (11, 11A) of the inner face (16) of each polar plate (10, 10A) is in the form of a double nested spiral joining together at the center.

6. Fuel cell according to claim 1, characterised in that the stack of the basic elements is kept tight by tie-rods (2) passing through each polar plate (10).

7. Fuel cell according to claim 1, characterised in that the relief on the outer face (15) of each polar plate (10) has a thrust pad (25) and bushings (17) around the holes (12A) forming the manifolds, and bushings (26) around the holes (12B) reserved only for the tie rods (2).

8. Fuel cell according to claim 7, characterised in that it comprises a bushing O-ring (20), on each bushing (17).

9. Fuel cell according to claim 7, characterised in that the bushings (17, 26) in each polar plate are brazed on the outer face (15) of the adjacent polar plate.

10. Fuel cell according to claim 1, characterised in that it has a round section and the circulation channel (11C) on each inner face of each polar plate (10C) is in the form of a nested double zigzag beginning and ending at one side and meeting at the other side.

11. Fuel cell according to claim 1, characterised in that it has a round section, and the circulation channel (11B) on each inner face of each polar plate (10B) is in the form of a zigzag going from one side of the polar plate (10B) to the other side.

12. Fuel cell according to claim 1, characterised in that a global peripheral seal (23) is provided between the two polar plates (10, 10A, 10B, 10C) in two adjacent basic elements.
